(19) United States
(12) Patent Application Publication
(10) Pub. No.: US 2026/0166529 A1
(43) Pub. Date: Jun. 18, 2026

(54) METAL OXIDE CATALYST AND METHOD OF SELECTIVELY AND CHEMICALLY REDUCING CARBON DIOXIDE

(71) Applicant: INDUSTRIAL TECHNOLOGY RESEARCH INSTITUTE, Hsinchu (TW)

(72) Inventors: Kuo-Ching WU, Hsinchu City (TW); Pao-Tsern LIN, Zhubei City (TW); Hsi-Yen HSU, Hsinchu City (TW); Chao-Huang CHEN, Hsinchu City (TW); Cheng-Hsun LI, Guanxi Township (TW); Yen-Chih CHEN, Hsinchu City (TW); Ying-Chieh LEE, Hsinchu City (TW)

(73) Assignee: INDUSTRIAL TECHNOLOGY RESEARCH INSTITUTE, Hsinchu (TW)

(21) Appl. No.: 19/257,829

(22) Filed: Jul. 2, 2025

(30) Foreign Application Priority Data
Dec. 12, 2024 (TW) 113148372

(51) Int. Cl. B01J 23/889; B01J 23/00; B01J 37/00; B01J 37/03; B01J 37/06; B01J 37/08; C01B 3/40

(52) U.S. Cl. CPC B01J 23/8892; B01J 23/002; B01J 37/009; B01J 37/031; B01J 37/06; B01J 37/08; C01B 3/40; B01J 2523/3706; B01J 2523/3712; B01J 2523/72; B01J 2523/842; C01B 2203/0238; C01B 2203/1047; C01B 2203/1088; C01B 2203/1241

(57) ABSTRACT

Disclosed is a method of selectively and chemically reducing carbon dioxide. The method includes bringing a gaseous mixture of carbon dioxide, methane, and hydrogen into contact with a metal oxide catalyst to form a syngas containing carbon monoxide and hydrogen. The metal oxide catalyst has a chemical formula of Fe₁MnₐM_{b}Oₓ, wherein M is Ce or La, a is 0.1 to 0.5, b is 0.1 to 0.3, and x is chemical stoichiometry.

### CROSS REFERENCE TO RELATED APPLICATIONS

The present application is based on, and claims priority from, Taiwan Application Serial Number 113148372, filed on Dec. 12, 2024, the disclosure of which is hereby expressly incorporated by reference herein in its entirety.

### TECHNICAL FIELD

This application relates to a metal oxide catalyst, and in particular, to a method of selectively and chemically reducing carbon dioxide using the metal oxide catalyst.

### BACKGROUND

Carbon dioxide and methane can be directly converted to hydrogen and carbon monoxide, and the reaction proceeds as follows: CO₂+CH₄→2CO+2H₂. The conversion reaction is usually performed in the presence of nickel or ruthenium catalyst at a temperature of 850° C. to 1000° C. This high-temperature process consumes a large amount of energy. Accordingly, there is a need for a catalyst that lowers the temperature of the conversion reaction.

### SUMMARY

One embodiment of the disclosure provides a metal oxide catalyst having a chemical formula of Fe₁MnₐM_{b}Oₓ, wherein M is Ce or La, a is 0.1 to 0.5, b is 0.1 to 0.3, and x is chemical stoichiometry.

Another embodiment of the disclosure provides a method of selectively and chemically reducing carbon dioxide, the method comprising bringing a gaseous mixture of carbon dioxide, methane, and hydrogen into contact with the described metal oxide catalyst to form a syngas comprising carbon monoxide and hydrogen.

### DETAILED DESCRIPTION

Disclosed embodiments provide a novel catalyst and process technology for reducing carbon dioxide with methane in the presence of hydrogen. In particular, the inventors have found that according to embodiments, certain metal oxide catalysts may be employed in selective reduction reactions in which methane (CH₄) and carbon dioxide (CO₂) are recombined at unexpectedly low temperatures, e.g., 600° C. or less, to provide carbon monoxide (CO) and hydrogen (H₂). These catalysts and methods allow for surprisingly economical reduction in carbon footprint by, for example, producing more hydrogen and less water byproduct than conventional methods. A detailed description is given in the following discussion of disclosed embodiments.

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a metal oxide catalyst including, but not limited to, iron (Fe), manganese (Mn), and cerium (Ce) or lanthanum (La). In exemplary embodiments, the metal oxide catalyst has the general chemical formula of Fe₁MnₐMb_{O}x. In this general formula, M may be Ce or La. The “a” in the general formula may be in a range of 0.1 to 0.5, 0.11 to 0.49, 0.12 to 0.48, 0.13 to 0.46, 0.14 to 0.43, 0.2 to 0.4, 0.25 to 0.35, or 0.3 to 0.35. The “b” in the general formula may be in a range of 0.1 to 0.3, −0.11 to 0.29, 0.12 to 0.29, 0.13 to 0.29, 0.14 to 0.28, 0.15 to 0.25, 0.18 to 0.23, or 0.19 to 0.21. The “x” may be determined according to the resulting chemical stoichiometry, according to methods known in the art.

Another embodiment of the disclosure provides a method of selectively and chemically reducing carbon dioxide. Under typical reaction conditions, in the presence of hydrogen, carbon dioxide will preferentially undergo a reduction reaction with hydrogen, while methane is unable to compete with carbon dioxide for hydrogen, causing no significant reaction between carbon dioxide and methane. In embodiments, the presence of hydrogen is important for methane to react with carbon dioxide and undergo a reduction reaction to form carbon monoxide. The term “selectivity”, as used herein, means that methane can only undergo the reduction reaction with carbon dioxide under specific conditions, such as in the presence of hydrogen and the designated catalyst used in the present disclosure.

The metal oxide catalyst disclosed herein may be particularly suitable for selectively and chemically reducing carbon dioxide. According to embodiments, the reduction reaction may proceed according to reaction Formula I as shown below:

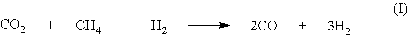

Even though the reactants and products both include H₂, the reaction may not be simplified as CO₂+CH₄→2CO+2H₂ since H₂ is an important reactant in the above equation. If the reactants are free of H₂, it is difficult to convert CO₂ and CH₄ to CO and H₂ using the disclosed catalyst system and the reaction conditions (e.g., low temperature).

Selection of the elements in the disclosed metal oxide catalyst is important in the disclosed embodiments. The inventors have found that employing a metal oxide catalyst having the general chemical formula of Fe₁MnₐM_{b}Oₓ to be particularly beneficial in selectively and chemically reducing carbon dioxide, i.e., arbitrarily replacing the elements in this general formula with other elements may reduce efficacy of the catalyst. For example, if Mn, Ce, or La is replaced with another element such as Cu or Ni, the process of selectively and chemically reducing carbon dioxide may not be performed effectively. If the amount of Mn is too low, the reactants may need more H₂ which increases the cost. If the amount of Mn is too high, the conversion rate of CO₂ may be decreased. If the amount of La or Ce is too low, the process of selectively and chemically reducing carbon dioxide may not be performed effectively. If the amount of La or Ce is too high, it may result in insufficient hydrogen production and the occurrence of another side reaction(s).

The metal oxide catalyst may be formed by any suitable method known in the art. In some embodiments, the metal oxide catalyst may be formed by the following steps. First, iron nitrate, manganese nitrate, and lanthanum nitrate (or cerium nitrate) are weighed according to chemical stoichiometry and dissolved in water, and the pH value of this aqueous solution of the metal salts is adjusted by alkaline solution (e.g., ammonia water, sodium hydroxide aqueous solution, potassium hydroxide aqueous solution, sodium carbonate aqueous solution, or potassium carbonate aqueous solution) to 8 to 10 (e.g., 9) and kept for 1 hour to 3 hours (e.g., 2 hours) to produce a precipitate. If the pH value of the aqueous solution is higher than 10, the particle size of the precipitate may be too large. If the pH value of the aqueous solution is lower than 8, the precipitate may not be efficiently produced. The precipitate is then collected by filtering, and the filtered cake is washed by water, baked, and then sintered (e.g., 400° C. to 500° C., such as 450° C.) to obtain the metal oxide catalyst having the general formula of Fe₁MnₐLa_{b}Oₓ (or Fe₁MnₐCe_{b}Oₓ). It should be understood that the method of forming the metal oxide catalyst is merely an example, and that one skilled in the art may utilize any method to form the metal oxide catalyst and be not limited to the above method.

In embodiments, the method may include bringing a gaseous mixture of carbon dioxide, methane, and hydrogen into contact with the metal oxide catalyst to form a syngas containing carbon monoxide and hydrogen according to the reaction Formula I above. It should be understood that reaction Formula I is the primary reaction, but other side reactions and byproducts are possible. As such, the syngas may contain byproducts and un-reacted reactants. For example, the syngas may further include, but is not limited to, methane, carbon dioxide, and water.

Without intending to be bound by theory, it is believed that the metal oxide catalyst selectively and chemically reduces carbon dioxide under the disclosed conditions by facilitating the role of methane as a reactant and stabilizing the reaction.

In some embodiments, the gas hourly space velocity (GHSV) of the gaseous mixture may be controlled to be within a specified range. For example, the gaseous mixture may have a GHSV in a range of 1000 h⁻¹ to 2500 h⁻¹.

If the gas hourly space velocity of the gaseous mixture is too low, the unit catalyst efficiency may be too low and its economic benefits may be insufficient. If the gas hourly space velocity of the gaseous mixture is too high, the contact time of the gaseous mixture and the metal oxide catalyst may be insufficient, and the gaseous mixture (i.e., carbon dioxide, methane, and hydrogen) may not be efficiently converted to carbon monoxide and hydrogen.

In some embodiments, the molar ratio of the carbon dioxide and the methane in the gaseous mixture is in a range of 1:0.5 to 1:2.

If the amount of the methane is too low, the hydrogen production may be reduced. If the amount of the methane is too high, the amount of un-reacted methane may increase, raising the cost of separating and recycling the methane from the product.

In some embodiments, the molar ratio of the carbon dioxide and the hydrogen in the gaseous mixture is 1:0.5 to 1:2.

If the amount of the hydrogen is too low, the process of selectively and chemically reducing the carbon dioxide may not be performed effectively. If the amount of the hydrogen is too high, it may inhibit the reaction of methane and reduce the hydrogen production.

In some embodiments, the temperature at which the step of bringing the gaseous mixture in contact with the metal oxide catalyst is performed at a temperature range of 280° C. to 600° C., such as 400° C. to 600° C. If the reaction temperature is too low, the process of selectively and chemically reducing the carbon dioxide may not be performed. If the reaction temperature is too high, the produced hydrogen may react with the carbon dioxide causing lower hydrogen production.

In some embodiments, the pressure at which the step of bringing the gaseous mixture in contact with the metal oxide catalyst is performed under a gauge pressure in a range of 0 atm to 2 atm, such as 1 atm to 1.2 atm.

In some embodiments, the reaction pressure may be a normal pressure (1 atm, and the corresponding gauge pressure is 0 atm) to reduce the cost associated with applying pressure to the gaseous mixture. Note that when the absolute pressure is 0 atm, it equals to vacuum. When the gauge pressure is 0 atm, it means an atmosphere pressure (the standard is 1 atm, but it varies slightly in different locations). In other words, the absolute pressure is higher than the gauge pressure by 1 atm, and the pressure disclosed herein is the gauge pressure.

Below, exemplary embodiments will be described in detail so as to be easily realized by a person having ordinary knowledge in the art. The inventive concept may be embodied in various forms without being limited to the exemplary embodiments set forth herein.

### EXAMPLES

The following examples are provided for better understanding of exemplary embodiments. It should be appreciated that this disclosure is not intended to be limited to these specific examples and that one of ordinary skill in the art would understand that the following examples may be embodied in many different forms and should not be construed as limited to the exemplary embodiments set forth therein.

The following Experiments including Examples and Comparative Examples.

### Experiment 1

Iron nitrate, manganese nitrate, and lanthanum nitrate were weighed according to chemical stoichiometry and dissolved in water, and the pH value of this aqueous solution of the metal salts was adjusted by ammonia water to 9 and kept for 2 hours to produce a precipitate. The precipitate was collected by filtering, and the filtered cake was washed by water, baked, and then sintered (450° C.) to obtain a metal oxide catalyst Fe₁Mn_{0.43}La_{0.14}Oₓ (the element ratio was confirmed by ICP).

### Comparative Example 1A

The metal oxide catalyst (Fe₁Mn_{0.43}La_{0.14}Oₓ) was sieved to obtain 100 mL of metal oxide catalyst powder with 8 mesh to 12 mesh, which was then filled into a 1-inch reactor. A gaseous mixture of carbon dioxide and methane having a total gas hourly space velocity of 1200 hr⁻¹ (CO₂=1000 mL/min, CH₄=1000 mL/min) was introduced into the reactor at a reaction temperature of 450° C. under a reaction gauge pressure of 1.06 atm (15.7 psi). The gas composition of the product was analyzed by Gas Chromatography (such as simultaneously measured and calculated through a column Carboxen-1010 PLOT, 30 m*0.53 mm ID with TCD detector, and a column VB-1, 30 m*0.53 mm ID with FID detector). The same analysis would be applied in the following examples. As determined from the analysis result (hydrogen and carbon monoxide were not detected), the gaseous mixture lacking hydrogen could not undergo the reaction.

### Comparative Example 1B

A gaseous mixture of carbon dioxide and methane having a total gas hourly space velocity of 1200 hr⁻¹ (CO₂=1000 mL/min, CH₄=1000 mL/min) was introduced into the reactor filled with the metal oxide catalyst Fe₁Mn_{0.43}La_{0.14}Oₓ at a reaction temperature of 550° C. under a reaction gauge pressure of 1.06 atm (15.7 psi). As determined from analyzing the result of the gas composition of the product (hydrogen and carbon monoxide were not detected), the gaseous mixture lacking hydrogen could not undergo the reaction even when the temperature was increased to 550° C.

### Comparative Example 1C

A gaseous mixture of carbon dioxide and hydrogen having a total gas hourly space velocity of 1200 hr⁻¹ (CO₂=1000 mL/min, H₂=1000 mL/min) was introduced into the reactor filled with the metal oxide catalyst Fe₁Mn_{0.43}La_{0.14}Oₓ at a reaction temperature of 450° C. under a reaction gauge pressure of 1.06 atm (15.7 psi). As determined from analyzing the result of the gas composition of the product, in which the carbon dioxide content was 729 mL/min (i.e., the conversion rate of the carbon dioxide was 27.1%), the methane content was 4 mL/min, the hydrogen content was 718 mL/min (i.e., the reaction consumed 282 mL/min of hydrogen), the carbon monoxide content was 267 mL/min, and the water content was 274 mL/min. When the gaseous mixture lacked methane, the reaction produced a lot of water byproduct and consumed hydrogen.

### Example 1A

A gaseous mixture of carbon dioxide, methane, and hydrogen having a total gas hourly space velocity of 1800 hr⁻¹ (CO₂=1000 mL/min, CH₄=1000 mL/min, H₂=1000 mL/min) was introduced into the reactor filled with the metal oxide catalyst Fe₁Mn_{0.43}La_{0.14}Oₓ at a reaction temperature of 450° C. under a reaction gauge pressure of 1.06 atm (15.7 psi). As determined from analyzing the result of the gas composition of the product, in which the carbon dioxide content was 841 mL/min (i.e., the conversion rate of the carbon dioxide was 15.9%), the methane content was 868 mL/min, the hydrogen content was 1236 mL/min (i.e., the reaction produced 236 mL/min of hydrogen), the carbon monoxide content was 291 mL/min, and the water content was 28 mL/min. The metal oxide catalyst in this Example could convert the gaseous mixture (containing carbon dioxide, methane, and hydrogen) to carbon monoxide and hydrogen, and produced less water byproduct.

### Example 1B

A gaseous mixture of carbon dioxide, methane, and hydrogen having a total gas hourly space velocity of 1500 hr⁻¹ (CO₂=1000 mL/min, CH₄=1000 mL/min, H₂=500 mL/min) was introduced into the reactor filled with the metal oxide catalyst Fe₁Mn_{0.43}La_{0.14}Oₓ at a reaction temperature of 450° C. under a reaction gauge pressure of 1.06 atm (15.7 psi). As determined from analyzing the result of the gas composition of the product, in which the carbon dioxide content was 847 mL/min (i.e., the conversion rate of the carbon dioxide was 15.3%), the methane content was 876 mL/min, the hydrogen content was 720 mL/min (i.e., the reaction produced 220 mL/min of hydrogen), the carbon monoxide content was 278 mL/min, and the water content was 29 mL/min. The metal oxide catalyst in this Example could convert the gaseous mixture (containing carbon dioxide, methane, and hydrogen) to carbon monoxide and hydrogen, and produced less water byproduct.

### Comparative Example 1D

A gaseous mixture of carbon dioxide and hydrogen having a total gas hourly space velocity of 1200 hr⁻¹ (CO₂=1000 mL/min, H₂=1000 mL/min) was introduced into the reactor filled with the metal oxide catalyst Fe₁Mn_{0.43}La_{0.14}Oₓ at a reaction temperature of 550° C. under a reaction gauge pressure of 1.06 atm (15.7 psi). As determined from analyzing the result of the gas composition of the product, in which the carbon dioxide content was 652 mL/min (i.e., the conversion rate of the carbon dioxide was 34.8%), the methane content was 1.1 mL/min, the hydrogen content was 648 mL/min (i.e., the reaction consumed 352 mL/min of hydrogen), the carbon monoxide content was 347 mL/min, and the water content was 349 mL/min. When the gaseous mixture lacked methane, the reaction produced a lot of water byproduct and consumed hydrogen.

### Example 1C

A gaseous mixture of carbon dioxide, methane, and hydrogen having a total gas hourly space velocity of 1800 hr⁻¹ (CO₂=1000 mL/min, CH₄=1000 mL/min, H₂=1000 mL/min) was introduced into the reactor filled with the metal oxide catalyst Fe₁Mn_{0.43}La_{0.14}Oₓ at a reaction temperature of 550° C. under a reaction gauge pressure of 1.06 atm (15.7 psi). As determined from analyzing the result of the gas composition of the product, in which the carbon dioxide content was 746 mL/min (i.e., the conversion rate of the carbon dioxide was 25.4%), the methane content was 848 mL/min, the hydrogen content was 1201 mL/min (i.e., the reaction produced 201 mL/min of hydrogen), the carbon monoxide content was 406 mL/min, and the water content was 102 mL/min. The metal oxide catalyst in this Example could convert the gaseous mixture (containing carbon dioxide, methane, and hydrogen) to carbon monoxide and hydrogen, and produced less water byproduct.

### EXPERIMENT 2

Iron nitrate, manganese nitrate, and lanthanum nitrate were weighed according to chemical stoichiometry and dissolved in water, and the pH value of this aqueous solution of the metal salts was adjusted by ammonia water to 9 and kept for 2 hours to produce a precipitate. The precipitate was collected by filtering, and the filtered cake was washed by water, baked, and then sintered (450° C.) to obtain a metal oxide catalyst Fe₁Mn_{0.43}La_{0.28}Oₓ (the element ratio was confirmed by ICP).

### Comparative Example 2A

The metal oxide catalyst (Fe₁Mn_{0.43}La_{0.28}Oₓ) was sieved to obtain 100 mL of metal oxide catalyst powder with 8 mesh to 12 mesh, which was then filled into a 1-inch reactor. A gaseous mixture of carbon dioxide and methane having a total gas hourly space velocity of 1200 hr⁻¹ (CO₂=1000 mL/min, CH₄=1000 mL/min) was introduced into the reactor at a reaction temperature of 550° C. under a reaction gauge pressure of 1.06 atm (15.7 psi). As determined from analyzing the result of the gas composition of the product (hydrogen and carbon monoxide were not detected), the gaseous mixture lacking hydrogen could not undergo the reaction.

### Comparative Example 2B

A gaseous mixture of carbon dioxide and hydrogen having a total gas hourly space velocity of 1200 hr⁻¹ (CO₂=1000 mL/min, H₂=1000 mL/min) was introduced into the reactor filled with the metal oxide catalyst Fe₁Mn_{0.43}La_{0.28}Oₓ at a reaction temperature of 550° C. under a reaction gauge pressure of 1.06 atm (15.7 psi). As determined from analyzing the result of the gas composition of the product, in which the carbon dioxide content was 622 mL/min (i.e., the conversion rate of the carbon dioxide was 37.8%), the methane content was 2 mL/min, the hydrogen content was 616 mL/min (i.e., the reaction consumed 384 mL/min of hydrogen), the carbon monoxide content was 376 mL/min, and the water content was 380 mL/min. When the gaseous mixture lacked methane, the reaction produced a lot of water byproduct and consumed hydrogen.

### Example 2A

A gaseous mixture of carbon dioxide, methane, and hydrogen having a total gas hourly space velocity of 1800 hr⁻¹ (CO₂=1000 mL/min, CH₄=1000 mL/min, H₂=1000 mL/min) was introduced into the reactor filled with the metal oxide catalyst Fe₁Mn_{0.43}La_{0.28}Oₓ at a reaction temperature of 550° C. under a reaction gauge pressure of 1.06 atm (15.7 psi). As determined from analyzing the result of the gas composition of the product, in which the carbon dioxide content was 693 mL/min (i.e., the conversion rate of the carbon dioxide was 30.7%), the methane content was 875 mL/min, the hydrogen content was 1008 mL/min (i.e., the reaction produced 8 mL/min of hydrogen), the carbon monoxide content was 412 mL/min, and the water content was 202 mL/min. The metal oxide catalyst in this Example could convert the gaseous mixture (containing carbon dioxide, methane, and hydrogen) to carbon monoxide and hydrogen, and produced less water byproduct.

### Example 2B

A gaseous mixture of carbon dioxide, methane, and hydrogen having a total gas hourly space velocity of 1950 hr⁻¹ (CO₂=1000 mL/min, CH₄=1250 mL/min, H₂=1000 mL/min) was introduced into the reactor filled with the metal oxide catalyst Fe₁Mn_{0.43}La_{0.28}Oₓ at a reaction temperature of 550° C. under a reaction gauge pressure of 1.06 atm (15.7 psi). As determined from analyzing the result of the gas composition of the product, in which the carbon dioxide content was 705 mL/min (i.e., the conversion rate of the carbon dioxide was 29.5%), the methane content was 1134 mL/min, the hydrogen content was 1054 mL/min (i.e., the reaction produced 54 mL/min of hydrogen), the carbon monoxide content was 411 mL/min, and the water content was 179 mL/min. Increasing the methane ratio in the gaseous mixture could produce more hydrogen and less water byproduct.

### Example 2C

A gaseous mixture of carbon dioxide, methane, and hydrogen having a total gas hourly space velocity of 2100 hr⁻¹ (CO₂=1000 mL/min, CH₄=1500 mL/min, H₂=1000 mL/min) was introduced into the reactor filled with the metal oxide catalyst Fe₁Mn_{0.43}La_{0.28}Oₓ at a reaction temperature of 550° C. under a reaction gauge pressure of 1.06 atm (15.7 psi). As determined from analyzing the result of the gas composition of the product, in which the carbon dioxide content was 730 mL/min (i.e., the conversion rate of the carbon dioxide was 27.0%), the methane content was 1349 mL/min, the hydrogen content was 1182 mL/min (i.e., the reaction produced 182 mL/min of hydrogen), the carbon monoxide content was 420 mL/min, and the water content was 119 mL/min. Increasing the methane ratio in the gaseous mixture could produce more hydrogen and less water byproduct.

### Example 2D

A gaseous mixture of carbon dioxide, methane, and hydrogen having a total gas hourly space velocity of 2250 hr⁻¹ (CO₂=1000 mL/min, CH₄=1750 mL/min, H₂=1000 mL/min) was introduced into the reactor filled with the metal oxide catalyst Fe₁Mn_{0.43}La_{0.28}Oₓ at a reaction temperature of 550° C. under a reaction gauge pressure of 1.06 atm (15.7 psi). As determined from analyzing the result of the gas composition of the product, in which the carbon dioxide content was 740 mL/min (i.e., the conversion rate of the carbon dioxide was 26.0%), the methane content was 1588 mL/min, the hydrogen content was 1227 mL/min (i.e., the reaction produced 227 mL/min of hydrogen), the carbon monoxide content was 422 mL/min, and the water content was 98 mL/min. Increasing the methane ratio in the gaseous mixture could produce more hydrogen and less water byproduct.

### Experiment 3

Iron nitrate, manganese nitrate, and lanthanum nitrate were weighed according to chemical stoichiometry and dissolved in water, and the pH value of this aqueous solution of the metal salts was adjusted by ammonia water to 9 and kept for 2 hours to produce a precipitate. The precipitate was collected by filtering, and the filtered cake was washed by water, baked, and then sintered (450° C.) to obtain a metal oxide catalyst Fe₁Mn_{0.14}La_{0.14}Oₓ (the element ratio was confirmed by ICP).

### Comparative Example 3A

The metal oxide catalyst (Fe₁Mn_{0.14}La_{0.14}Oₓ) was sieved to obtain 100 mL of metal oxide catalyst powder with 8 mesh to 12 mesh, which was then filled into a 1-inch reactor. A gaseous mixture of carbon dioxide and methane having a total gas hourly space velocity of 1200 hr⁻¹ (CO₂=1000 mL/min, CH₄=1000 mL/min) was introduced into the reactor at a reaction temperature of 550° C. under a reaction gauge pressure of 1 atm (14.7 psi). As determined from analyzing the result of the gas composition of the product (hydrogen and carbon monoxide were not detected), the gaseous mixture lacking hydrogen could not undergo the reaction.

### Comparative Example 3B

A gaseous mixture of carbon dioxide and hydrogen having a total gas hourly space velocity of 1200 hr⁻¹ (CO₂=1000 mL/min, H₂=1000 mL/min) was introduced into the reactor filled with the metal oxide catalyst Fe₁Mn_{0.14}La_{0.14}Oₓ at a reaction temperature of 550° C. under a reaction gauge pressure of 1 atm (14.7 psi). As determined from analyzing the result of the gas composition of the product, in which the carbon dioxide content was 612 mL/min (i.e., the conversion rate of the carbon dioxide was 38.8%), the methane content was 1 mL/min, the hydrogen content was 609 mL/min (i.e., the reaction consumed 391 mL/min of hydrogen), the carbon monoxide content was 387 mL/min, and the water content was 389 mL/min. When the gaseous mixture lacked methane, the reaction produced a lot of water byproduct and consumed hydrogen.

### Example 3A

A gaseous mixture of carbon dioxide, methane, and hydrogen having a total gas hourly space velocity of 1800 hr⁻¹ (CO₂=1000 mL/min, CH₄=1000 mL/min, H₂=1000 mL/min) was introduced into the reactor filled with the metal oxide catalyst Fe₁Mn_{0.14}La_{0.14}Oₓ at a reaction temperature of 550° C. under a reaction gauge pressure of 1 atm (14.7 psi). As determined from analyzing the result of the gas composition of the product, in which the carbon dioxide content was 650 mL/min (i.e., the conversion rate of the carbon dioxide was 35%), the methane content was 908 mL/min, the hydrogen content was 926 mL/min (i.e., the reaction consumed 74 mL/min of hydrogen), the carbon monoxide content was 443 mL/min, and the water content was 258 mL/min. The metal oxide catalyst in this Example could convert the gaseous mixture (containing carbon dioxide, methane, and hydrogen) to carbon monoxide and hydrogen, and produced less water byproduct.

### Example 3B

A gaseous mixture of carbon dioxide, methane, and hydrogen having a total gas hourly space velocity of 1950 hr⁻¹ (CO₂=1000 mL/min, CH₄=1250 mL/min, H₂=1000 mL/min) was introduced into the reactor filled with the metal oxide catalyst Fe₁Mn_{0.14}La_{0.14}Oₓ at a reaction temperature of 550° C. under a reaction gauge pressure of 1 atm (14.7 psi). As determined from analyzing the result of the gas composition of the product, in which the carbon dioxide content was 709 mL/min (i.e., the conversion rate of the carbon dioxide was 29.1%), the methane content was 1126 mL/min, the hydrogen content was 1080 mL/min (i.e., the reaction produced 80 mL/min of hydrogen), the carbon monoxide content was 415 mL/min, and the water content was 168 mL/min. Increasing the methane ratio in the gaseous mixture could produce more hydrogen and less water byproduct.

### Example 3C

A gaseous mixture of carbon dioxide, methane, and hydrogen having a total gas hourly space velocity of 2100 hr⁻¹ (CO₂=1000 mL/min, CH₄=1500 mL/min, H₂=1000 mL/min) was introduced into the reactor filled with the metal oxide catalyst Fe₁Mn_{0.14}La_{0.14}Oₓ at a reaction temperature of 550° C. under a reaction gauge pressure of 1 atm (14.7 psi). As determined from analyzing the result of the gas composition of the product, in which the carbon dioxide content was 717 mL/min (i.e., the conversion rate of the carbon dioxide was 28.3%), the methane content was 1359 mL/min, the hydrogen content was 1141 mL/min (i.e., the reaction produced 141 mL/min of hydrogen), the carbon monoxide content was 424 mL/min, and the water content was 142 mL/min. Increasing the methane ratio in the gaseous mixture could produce more hydrogen and less water byproduct.

### Example 3D

A gaseous mixture of carbon dioxide, methane, and hydrogen having a total gas hourly space velocity of 2250 hr⁻¹ (CO₂=1000 mL/min, CH₄=1750 mL/min, H₂=1000 mL/min) was introduced into the reactor filled with the metal oxide catalyst Fe₁Mn_{0.14}La_{0.14}Oₓ at a reaction temperature of 550° C. under a reaction gauge pressure of 1 atm (14.7 psi). As determined from analyzing the result of the gas composition of the product, in which the carbon dioxide content was 729 mL/min (i.e., the conversion rate of the carbon dioxide was 27.1%), the methane content was 1591 mL/min, the hydrogen content was 1206 mL/min (i.e., the reaction produced 206 mL/min of hydrogen), the carbon monoxide content was 430 mL/min, and the water content was 112 mL/min. Increasing the methane ratio in the gaseous mixture could produce more hydrogen and less water byproduct.

### Experiment 4

Iron nitrate, manganese nitrate, and cerium nitrate were weighed according to chemical stoichiometry and dissolved in water, and the pH value of this aqueous solution of the metal salts was adjusted by ammonia water to 9 and kept for 2 hours to produce a precipitate. The precipitate was collected by filtering, and the filtered cake was washed by water, baked, and then sintered (450° C.) to obtain a metal oxide catalyst Fe₁Mn_{0.43}Ce_{0.14}Oₓ (the element ratio was confirmed by ICP).

### Comparative Example 4A

The metal oxide catalyst (Fe₁Mn_{0.43}Ce_{0.14}Oₓ) was sieved to obtain 100 mL of metal oxide catalyst powder with 8 mesh to 12 mesh, which was then filled into a 1-inch reactor. A gaseous mixture of carbon dioxide and methane having a total gas hourly space velocity of 1200 hr⁻¹ (CO₂=1000 mL/min, CH₄=1000 mL/min) was introduced into the reactor at a reaction temperature of 550° C. under a reaction gauge pressure of 1 atm (14.7 psi). As determined from analyzing the result of the gas composition of the product (hydrogen and carbon monoxide were not detected), the gaseous mixture lacking hydrogen could not undergo the reaction.

### Comparative Example 4B

A gaseous mixture of carbon dioxide and hydrogen having a total gas hourly space velocity of 1200 hr⁻¹ (CO₂=1000 mL/min, H₂=1000 mL/min) was introduced into the reactor filled with the metal oxide catalyst Fe₁Mn_{0.43}Ce_{0.14}Oₓ at a reaction temperature of 550° C. under a reaction gauge pressure of 1 atm (14.7 psi). As determined from analyzing the result of the gas composition of the product, in which the carbon dioxide content was 646 mL/min (i.e., the conversion rate of the carbon dioxide was 35.4%), the methane content was 0.3 mL/min, the hydrogen content was 645 mL/min (i.e., the reaction consumed 355 mL/min of hydrogen), the carbon monoxide content was 354 mL/min, and the water content was 354 mL/min. When the gaseous mixture lacked methane, the reaction produced a lot of water byproduct and consumed hydrogen.

### Example 4A

A gaseous mixture of carbon dioxide, methane, and hydrogen having a total gas hourly space velocity of 1800 hr⁻¹ (CO₂=1000 mL/min, CH₄=1000 mL/min, H₂=1000 mL/min) was introduced into the reactor filled with the metal oxide catalyst Fe₁Mn_{0.43}Ce_{0.14}Oₓ at a reaction temperature of 550° C. under a reaction gauge pressure of 1 atm (14.7 psi). As determined from analyzing the result of the gas composition of the product, in which the carbon dioxide content was 708 mL/min (i.e., the conversion rate of the carbon dioxide was 29.2%), the methane content was 886 mL/min, the hydrogen content was 1050 mL/min (i.e., the reaction produced 50 mL/min of hydrogen), the carbon monoxide content was 406 mL/min, and the water content was 178 mL/min. The metal oxide catalyst in this Example could convert the gaseous mixture (containing carbon dioxide, methane, and hydrogen) to carbon monoxide and hydrogen, and produced less water byproduct.

### Example 4B

A gaseous mixture of carbon dioxide, methane, and hydrogen having a total gas hourly space velocity of 1950 hr⁻¹ (CO₂=1000 mL/min, CH₄=1250 mL/min, H₂=1000 mL/min) was introduced into the reactor filled with the metal oxide catalyst Fe₁Mn_{0.43}Ce_{0.14}Oₓ at a reaction temperature of 550° C. under a reaction gauge pressure of 1 atm (14.7 psi). As determined from analyzing the result of the gas composition of the product, in which the carbon dioxide content was 720 mL/min (i.e., the conversion rate of the carbon dioxide was 28%), the methane content was 1112 mL/min, the hydrogen content was 1133 mL/min (i.e., the reaction produced 133 mL/min of hydrogen), the carbon monoxide content was 417 mL/min, and the water content was 142 mL/min. Increasing the methane ratio in the gaseous mixture could produce more hydrogen and less water byproduct.

### Example 4C

A gaseous mixture of carbon dioxide, methane, and hydrogen having a total gas hourly space velocity of 2100 hr⁻¹ (CO₂=1000 mL/min, CH₄=1500 mL/min, H₂=1000 mL/min) was introduced into the reactor filled with the metal oxide catalyst Fe₁Mn_{0.43}Ce_{0.14}Oₓ at a reaction temperature of 550° C. under a reaction gauge pressure of 1 atm (14.7 psi). As determined from analyzing the result of the gas composition of the product, in which the carbon dioxide content was 732 mL/min (i.e., the conversion rate of the carbon dioxide was 26.8%), the methane content was 1351 mL/min, the hydrogen content was 1180 mL/min (i.e., the reaction produced 180 mL/min of hydrogen), the carbon monoxide content was 417 mL/min, and the water content was 119 mL/min. Increasing the methane ratio in the gaseous mixture could produce more hydrogen and less water byproduct.

### Example 4D

A gaseous mixture of carbon dioxide, methane, and hydrogen having a total gas hourly space velocity of 2250 hr⁻¹ (CO₂=1000 mL/min, CH₄=1750 mL/min, H₂=1000 mL/min) was introduced into the reactor filled with the metal oxide catalyst Fe₁Mn_{0.43}Ce_{0.14}Oₓ at a reaction temperature of 550° C. under a reaction gauge pressure of 1 atm (14.7 psi). As determined from analyzing the result of the gas composition of the product, in which the carbon dioxide content was 728 mL/min (i.e., the conversion rate of the carbon dioxide was 27.2%), the methane content was 1587 mL/min, the hydrogen content was 1216 mL/min (i.e., the reaction produced 216 mL/min of hydrogen), the carbon monoxide content was 434 mL/min, and the water content was 109 mL/min. Increasing the methane ratio in the gaseous mixture could produce more hydrogen and less water byproduct.

### Experiment 5

Iron nitrate, manganese nitrate, and cerium nitrate were weighed according to chemical stoichiometry and dissolved in water, and the pH value of this aqueous solution of the metal salts was adjusted by ammonia water to 9 and kept for 2 hours to produce a precipitate. The precipitate was collected by filtering, and the filtered cake was washed by water, baked, and then sintered (450° C.) to obtain a metal oxide catalyst Fe₁Mn_{0.14}Ce_{0.28}Oₓ (the element ratio was confirmed by ICP).

### Comparative Example 5A

The metal oxide catalyst (Fe₁Mn_{0.14}Ce_{0.28}Oₓ) was sieved to obtain 100 mL of metal oxide catalyst powder with 8 mesh to 12 mesh, which was then filled into a 1-inch reactor. A gaseous mixture of carbon dioxide and methane having a total gas hourly space velocity of 1200 hr⁻¹ (CO₂=1000 mL/min, CH₄=1000 mL/min) was introduced into the reactor at a reaction temperature of 550° C. under a reaction gauge pressure of 1 atm (14.7 psi). As determined from analyzing the result of the gas composition of the product, the gaseous mixture lacking hydrogen could not undergo the reaction.

### Comparative Example 5B

A gaseous mixture of carbon dioxide and hydrogen having a total gas hourly space velocity of 1200 hr⁻¹ (CO₂=1000 mL/min, H₂=1000 mL/min) was introduced into the reactor filled with the metal oxide catalyst Fe₁Mn_{0.14}Ce_{0.28}Oₓ at a reaction temperature of 550° C. under a reaction gauge pressure of 1 atm (14.7 psi). As determined from analyzing the result of the gas composition of the product, in which the carbon dioxide content was 665 mL/min (i.e., the conversion rate of the carbon dioxide was 33.5%), the methane content was 0.4 mL/min, the hydrogen content was 663 mL/min (i.e., the reaction consumed 337 mL/min of hydrogen), the carbon monoxide content was 335 mL/min, and the water content was 336 mL/min. When the gaseous mixture lacked methane, the reaction produced a lot of water byproduct and consumed hydrogen.

### Example 5A

A gaseous mixture of carbon dioxide, methane, and hydrogen having a total gas hourly space velocity of 1500 hr⁻¹ (CO₂=1000 mL/min, CH₄=500 mL/min, H₂=1000 mL/min) was introduced into the reactor filled with the metal oxide catalyst Fe₁Mn_{0.14}Ce_{0.28}Oₓ at a reaction temperature of 550° C. under a reaction gauge pressure of 1 atm (14.7 psi). As determined from analyzing the result of the gas composition of the product, in which the carbon dioxide content was 672 mL/min (i.e., the conversion rate of the carbon dioxide was 32.8%), the methane content was 475 mL/min, the hydrogen content was 747 mL/min (i.e., the reaction consumed 253 mL/min of hydrogen), the carbon monoxide content was 353 mL/min, and the water content was 303 mL/min. The metal oxide catalyst in this Example could convert the gaseous mixture (containing carbon dioxide, methane, and hydrogen) to carbon monoxide and hydrogen, and produced less water byproduct.

### Example 5B

A gaseous mixture of carbon dioxide, methane, and hydrogen having a total gas hourly space velocity of 1800 hr⁻¹ (CO₂=1000 mL/min, CH₄=1000 mL/min, H₂=1000 mL/min) was introduced into the reactor filled with the metal oxide catalyst Fe₁Mn_{0.14}Ce_{0.28}Oₓ at a reaction temperature of 550° C. under a reaction gauge pressure of 1 atm (14.7 psi). As determined from analyzing the result of the gas composition of the product, in which the carbon dioxide content was 730 mL/min (i.e., the conversion rate of the carbon dioxide was 27%), the methane content was 905 mL/min, the hydrogen content was 1016 mL/min (i.e., the reaction produced 16 mL/min of hydrogen), the carbon monoxide content was 365 mL/min, and the water content was 175 mL/min. Increasing the methane ratio in the gaseous mixture could produce more hydrogen and less water byproduct.

### Example 5C

A gaseous mixture of carbon dioxide, methane, and hydrogen having a total gas hourly space velocity of 2100 hr⁻¹ (CO₂=1000 mL/min, CH₄=1500 mL/min, H₂=1000 mL/min) was introduced into the reactor filled with the metal oxide catalyst Fe₁Mn_{0.14}Ce_{0.28}Oₓ at a reaction temperature of 550° C. under a reaction gauge pressure of 1 atm (14.7 psi). As determined from analyzing the result of the gas composition of the product, in which the carbon dioxide content was 750 mL/min (i.e., the conversion rate of the carbon dioxide was 25%), the methane content was 1383 mL/min, the hydrogen content was 1101 mL/min (i.e., the reaction produced 101 mL/min of hydrogen), the carbon monoxide content was 368 mL/min, and the water content was 133 mL/min. Increasing the methane ratio in the gaseous mixture could produce more hydrogen and less water byproduct.

### Example 5D

A gaseous mixture of carbon dioxide, methane, and hydrogen having a total gas hourly space velocity of 2400 hr⁻¹ (CO₂=1000 mL/min, CH₄=1000 mL/min, H₂=2000 mL/min) was introduced into the reactor filled with the metal oxide catalyst Fe₁Mn_{0.14}Ce_{0.28}Oₓ at a reaction temperature of 550° C. under a reaction gauge pressure of 1 atm (14.7 psi). As determined from analyzing the result of the gas composition of the product, in which the carbon dioxide content was 567 mL/min (i.e., the conversion rate of the carbon dioxide was 43.3%), the methane content was 944 mL/min, the hydrogen content was 1736 mL/min (i.e., the reaction consumed 264 mL/min of hydrogen), the carbon monoxide content was 489 mL/min, and the water content was 377 mL/min. Increasing the hydrogen ratio in the gaseous mixture could produce more carbon monoxide.

### Experiment 6

### Comparative Example 6

Iron nitrate, manganese nitrate, and lanthanum nitrate were weighed according to chemical stoichiometry and dissolved in water, and the pH value of this aqueous solution of the metal salts was adjusted by ammonia water to 9 and kept for 2 hours to produce a precipitate. The precipitate was collected by filtering, and the filtered cake was washed by water, baked, and then sintered (450° C.) to obtain a metal oxide catalyst Fe₁Mn_{0.08}La_{0.28}Oₓ (the element ratio was confirmed by ICP).

The metal oxide catalyst (Fe₁Mn_{0.08}La_{0.28}Oₓ) was sieved to obtain 100 mL of metal oxide catalyst powder with 8 mesh to 12 mesh, which was then filled into a 1-inch reactor. A gaseous mixture of carbon dioxide, methane, and hydrogen having a total gas hourly space velocity of 1800 hr⁻¹ (CO₂=1000 mL/min, CH₄=1000 mL/min, H₂=1000 mL/min) was introduced into the reactor filled with the metal oxide catalyst Fe₁Mn_{0.08}La_{0.28}Oₓ at a reaction temperature of 550° Cl under a reaction gauge pressure of 1 atm (14.7 psi). As determined from analyzing the result of the gas composition of the product, in which the carbon dioxide content was 744 mL/min (i.e., the conversion rate of the carbon dioxide was 25.6%), the methane content was 1006 mL/min, the hydrogen content was 727 mL/min (i.e., the reaction consumed 273 mL/min of hydrogen), the carbon monoxide content was 251 mL/min, and the water content was 262 mL/min. The metal oxide catalyst having Mn amount that was too low consumed too much hydrogen and produced too much water byproduct

### Experiment 7

### Comparative Example 7

Iron nitrate, manganese nitrate, and lanthanum nitrate were weighed according to chemical stoichiometry and dissolved in water, and the pH value of this aqueous solution of the metal salts was adjusted by ammonia water to 9 and kept for 2 hours to produce a precipitate. The precipitate was collected by filtering, and the filtered cake was washed by water, baked, and then sintered (450° C.) to obtain a metal oxide catalyst Fe₁Mn_{0.6}La_{0.28}Oₓ (the element ratio was confirmed by ICP).

The metal oxide catalyst (Fe₁Mn_{0.6}La_{0.28}Oₓ) was sieved to obtain 100 mL of metal oxide catalyst powder with 8 mesh to 12 mesh, which was then filled into a 1-inch reactor. A gaseous mixture of carbon dioxide, methane, and hydrogen having a total gas hourly space velocity of 1800 hr⁻¹ (CO₂=1000 mL/min, CH₄=1000 mL/min, H₂=1000 mL/min) was introduced into the reactor filled with the metal oxide catalyst Fe₁Mn_{0.6}La_{0.28}Oₓ at a reaction temperature of 550° C. under a reaction gauge pressure of 1 atm (14.7 psi). As determined from analyzing the result of the gas composition of the product, in which the carbon dioxide content was 842 mL/min (i.e., the conversion rate of the carbon dioxide was 15.8%), the methane content was 945.3 mL/min, the hydrogen content was 1006 mL/min (i.e., the reaction produced 6 mL/min of hydrogen), the carbon monoxide content was 212 mL/min, and the water content was 103 mL/min. The metal oxide catalyst having excessive amount of Mn would result in a low conversion rate of carbon dioxide and low hydrogen production.

### Experiment 8

### Comparative Example 8

Iron nitrate, manganese nitrate, and lanthanum nitrate were weighed according to chemical stoichiometry and dissolved in water, and the pH value of this aqueous solution of the metal salts was adjusted by ammonia water to 9 and kept for 2 hours to produce a precipitate. The precipitate was collected by filtering, and the filtered cake was washed by water, baked, and then sintered (450° C.) to obtain a metal oxide catalyst Fe₁Mn_{0.14}La_{0.08}Oₓ (the element ratio was confirmed by ICP).

The metal oxide catalyst (Fe₁Mn_{0.14}La_{0.08}Oₓ) was sieved to obtain 100 mL of metal oxide catalyst powder with 8 mesh to 12 mesh, which was then filled into a 1-inch reactor. A gaseous mixture of carbon dioxide, methane, and hydrogen having a total gas hourly space velocity of 1800 hr⁻¹ (CO₂=1000 mL/min, CH₄=1000 mL/min, H₂=1000 mL/min) was introduced into the reactor filled with the metal oxide catalyst Fe₁Mn_{0.14}La_{0.08}Oₓ at a reaction temperature of 550° C. under a reaction gauge pressure of 1 atm (14.7 psi). As determined from analyzing the result of the gas composition of the product, the conversion rate of the carbon dioxide was less than 5%. The metal oxide catalyst with insufficient La amount was unable to catalyze the reaction.

### Experiment 9

### Comparative Example 9

Iron nitrate, manganese nitrate, and lanthanum nitrate were weighed according to chemical stoichiometry and dissolved in water, and the pH value of this aqueous solution of the metal salts was adjusted by ammonia water to 9 and kept for 2 hours to produce a precipitate. The precipitate was collected by filtering, and the filtered cake was washed by water, baked, and then sintered (450° C.) to obtain a metal oxide catalyst Fe₁Mn_{0.14}La_{0.35}Oₓ (the element ratio was confirmed by ICP).

The metal oxide catalyst (Fe₁Mn_{0.14}La_{0.35}Oₓ) was sieved to obtain 100 mL of metal oxide catalyst powder with 8 mesh to 12 mesh, which was then filled into a 1-inch reactor. A gaseous mixture of carbon dioxide, methane, and hydrogen having a total gas hourly space velocity of 1800 hr⁻¹ (CO₂=1000 mL/min, CH₄=1000 mL/min, H₂=1000 mL/min) was introduced into the reactor filled with the metal oxide catalyst Fe₁Mn_{0.14}La_{0.35}Oₓ at a reaction temperature of 550° C. under a reaction gauge pressure of 1 atm (14.7 psi). As determined from analyzing the result of the gas composition of the product, in which the carbon dioxide content was 731 mL/min (i.e., the conversion rate of the carbon dioxide was 26.9%), the methane content was 1036 mL/min, the hydrogen content was 621 mL/min (i.e., the reaction consumed 379 mL/min of hydrogen), the carbon monoxide content was 233 mL/min, and the water content was 306 mL/min. The metal oxide catalyst having excessive amount of La would consume hydrogen and produce an excessive amount of byproduct such as water.

### Experiment 10

### Comparative Example 10

Iron nitrate, manganese nitrate, and cerium nitrate were weighed according to chemical stoichiometry and dissolved in water, and the pH value of this aqueous solution of the metal salts was adjusted by ammonia water to 9 and kept for 2 hours to produce a precipitate. The precipitate was collected by filtering, and the filtered cake was washed by water, baked, and then sintered (450° C.) to obtain a metal oxide catalyst Fe₁Mn_{0.14}Ce_{0.08}Oₓ (the element ratio was confirmed by ICP).

The metal oxide catalyst (Fe₁Mn_{0.14}Ce_{0.08}Oₓ) was sieved to obtain 100 mL of metal oxide catalyst powder with 8 mesh to 12 mesh, which was then filled into a 1-inch reactor. A gaseous mixture of carbon dioxide, methane, and hydrogen having a total gas hourly space velocity of 1800 hr⁻¹ (CO₂=1000 mL/min, CH₄=1000 mL/min, H₂=1000 mL/min) was introduced into the reactor filled with the metal oxide catalyst Fe₁Mn_{0.14}Ce_{0.08}Oₓ at a reaction temperature of 550° C. under a reaction gauge pressure of 1 atm (14.7 psi). As determined from analyzing the result of the gas composition of the product, the conversion rate of the carbon dioxide was less than 5%. The metal oxide catalyst having Ce amount that was too low was unable to catalyze the reaction.

### Experiment 11

### Comparative Example 11

Iron nitrate, manganese nitrate, and cerium nitrate were weighed according to chemical stoichiometry and dissolved in water, and the pH value of this aqueous solution of the metal salts was adjusted by ammonia water to 9 and kept for 2 hours to produce a precipitate. The precipitate was collected by filtering, and the filtered cake was washed by water, baked, and then sintered (450° C.) to obtain a metal oxide catalyst Fe₁Mn_{0.14}Ce_{0.35}Oₓ (the element ratio was confirmed by ICP).

The metal oxide catalyst (Fe₁Mn_{0.14}Ce_{0.35}Oₓ) was sieved to obtain 100 mL of metal oxide catalyst powder with 8 mesh to 12 mesh, which was then filled into a 1-inch reactor. A gaseous mixture of carbon dioxide, methane, and hydrogen having a total gas hourly space velocity of 1800 hr⁻¹ (CO₂=1000 mL/min, CH₄=1000 mL/min, H₂=1000 mL/min) was introduced into the reactor filled with the metal oxide catalyst Fe₁Mn_{0.14}Ce_{0.35}Oₓ at a reaction temperature of 550° C. under a reaction gauge pressure of 1 atm (14.7 psi). As determined from analyzing the result of the gas composition of the product, in which the carbon dioxide content was 744 mL/min (i.e., the conversion rate of the carbon dioxide was 25.6%), the methane content was 1049 mL/min, the hydrogen content was 621 mL/min (i.e., the reaction consumed 379 mL/min of hydrogen), the carbon monoxide content was 206 mL/min, and the water content was 305 mL/min. The metal oxide catalyst having excessive amount of Ce consumed hydrogen and produced an excessive amount of byproduct such as water.

### Experiment 12

### Comparative Example 12

Iron nitrate, copper nitrate, and lanthanum nitrate were weighed according to chemical stoichiometry and dissolved in water, and the pH value of this aqueous solution of the metal salts was adjusted by ammonia water to 9 and kept for 2 hours to produce a precipitate. The precipitate was collected by filtering, and the filtered cake was washed by water, baked, and then sintered (450° C.) to obtain a metal oxide catalyst Fe₁Cu_{0.14}La_{0.14}Oₓ (the element ratio was confirmed by ICP).

The metal oxide catalyst (Fe₁Cu_{0.14}La_{0.14}Oₓ) was sieved to obtain 100 mL of metal oxide catalyst powder with 8 mesh to 12 mesh, which was then filled into a 1-inch reactor. A gaseous mixture of carbon dioxide, methane, and hydrogen having a total gas hourly space velocity of 1800 hr⁻¹ (CO₂=1000 mL/min, CH₄=1000 mL/min, H₂=1000 mL/min) was introduced into the reactor filled with the metal oxide catalyst Fe₁Cu_{0.14}La_{0.14}Oₓ at a reaction temperature of 550° C. under a reaction gauge pressure of 1 atm (14.7 psi). As determined from analyzing the result of the gas composition of the product, methane did not participate in the reaction, but its concentration increased significantly in the presence of this metal oxide catalyst.

### Experiment 13

### Comparative Example 13

Iron nitrate, manganese nitrate, and copper nitrate were weighed according to chemical stoichiometry and dissolved in water, and the pH value of this aqueous solution of the metal salts was adjusted by ammonia water to 9 and kept for 2 hours to produce a precipitate. The precipitate was collected by filtering, and the filtered cake was washed by water, baked, and then sintered (450° C.) to obtain a metal oxide catalyst Fe₁Mn_{0.14}Cu_{0.14}Oₓ (the element ratio was confirmed by ICP).

The metal oxide catalyst (Fe₁Mn_{0.14}Cu_{0.14}Oₓ) was sieved to obtain 100 mL of metal oxide catalyst powder with 8 mesh to 12 mesh, which was then filled into a 1-inch reactor. A gaseous mixture of carbon dioxide, methane, and hydrogen having a total gas hourly space velocity of 1800 hr⁻¹ (CO₂=1000 mL/min, CH₄=1000 mL/min, H₂=1000 mL/min) was introduced into the reactor filled with the metal oxide catalyst Fe₁Mn_{0.14}Cu_{0.14}Oₓ at a reaction temperature of 550° C. under a reaction gauge pressure of 1 atm (14.7 psi). As determined from analyzing the result of the gas composition of the product, methane did not participate in the reaction, but its concentration increased significantly in the presence of this metal oxide catalyst.

### Experiment 14

### Comparative Example 14

Iron nitrate, nickel nitrate, and lanthanum nitrate were weighed according to chemical stoichiometry and dissolved in water, and the pH value of this aqueous solution of the metal salts was adjusted by ammonia water to 9 and kept for 2 hours to produce a precipitate. The precipitate was collected by filtering, and the filtered cake was washed by water, baked, and then sintered (450° C.) to obtain a metal oxide catalyst Fe₁Ni_{0.14}La_{0.14}Oₓ (the element ratio was confirmed by ICP).

The metal oxide catalyst (Fe₁Ni_{0.14}La_{0.14}Oₓ) was sieved to obtain 100 mL of metal oxide catalyst powder with 8 mesh to 12 mesh, which was then filled into a 1-inch reactor. A gaseous mixture of carbon dioxide, methane, and hydrogen having a total gas hourly space velocity of 1800 hr⁻¹ (CO₂=1000 mL/min, CH₄=1000 mL/min, H₂=1000 mL/min) was introduced into the reactor filled with the metal oxide catalyst Fe₁Ni_{0.14}La_{0.14}Oₓ at a reaction temperature of 550° C. under a reaction gauge pressure of 1 atm (14.7 psi). As determined from analyzing the result of the gas composition of the product, methane did not participate in the reaction, but its concentration increased significantly in the presence of this metal oxide catalyst.

### Experiment 15

### Comparative Example 15

Iron nitrate, manganese nitrate, nickel nitrate were weighed according to chemical stoichiometry and dissolved in water, and the pH value of this aqueous solution of the metal salts was adjusted by ammonia water to 9 and kept for 2 hours to produce a precipitate. The precipitate was collected by filtering, and the filtered cake was washed by water, baked, and then sintered (450° C.) to obtain a metal oxide catalyst Fe₁Mn_{0.14}Ni_{0.14}Oₓ (the element ratio was confirmed by ICP).

The metal oxide catalyst (Fe₁Mn_{0.14}Ni_{0.14}Oₓ) was sieved to obtain 100 mL of metal oxide catalyst powder with 8 mesh to 12 mesh, which was then filled into a 1-inch reactor. A gaseous mixture of carbon dioxide, methane, and hydrogen having a total gas hourly space velocity of 1800 hr⁻¹ (CO₂=1000 mL/min, CH₄=1000 mL/min, H₂=1000 mL/min) was introduced into the reactor filled with the metal oxide catalyst Fe₁Mn_{0.14}Ni_{0.14}Oₓ at a reaction temperature of 550° C. under a reaction gauge pressure of 1 atm (14.7 psi). As determined from analyzing the result of the gas composition of the product, methane did not participate in the reaction, but its concentration increased significantly in the presence of this metal oxide catalyst.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A metal oxide catalyst having a chemical formula of Fe₁MnₐM_{b}Oₓ, wherein M is Ce or La, a is 0.1 to 0.5, b is 0.1 to 0.3, and x is chemical stoichiometry.

2. The metal oxide catalyst as claimed in claim 1, wherein a is 0.14 to 0.43.

3. The metal oxide catalyst as claimed in claim 1, wherein b is 0.14 to 0.28.

4. A method of selectively and chemically reducing carbon dioxide, the method comprising:
bringing a gaseous mixture of carbon dioxide, methane, and hydrogen into contact with a metal oxide catalyst as claimed in claim 1 to form a syngas comprising carbon monoxide and hydrogen.

5. The method as claimed in claim 4, wherein the syngas further comprises methane, carbon dioxide, and water.

6. The method as claimed in claim 4, wherein the gaseous mixture has a gas hourly space velocity in a range of 1000 h⁻¹ to 2500 h⁻¹.

7. The method as claimed in claim 4, wherein the carbon dioxide and the methane in the gaseous mixture have a molar ratio in a range of 1:0.5 to 1:2.

8. The method as claimed in claim 4, wherein the carbon dioxide and the hydrogen in the gaseous mixture have a molar ratio in a range of 1:0.5 to 1:2.

9. The method as claimed in claim 4, wherein the step of bringing the gaseous mixture into contact with the metal oxide catalyst is performed at a temperature of 600° C. or less.

10. The method as claimed in claim 4, wherein the step of bringing the gaseous mixture into contact with the metal oxide catalyst is performed at a temperature in a range of 280° C. to 600° C.

11. The method as claimed in claim 4, wherein the step of bringing the gaseous mixture into contact with the metal oxide catalyst is performed at a temperature in a range of 450° C. to 550° C.

12. The method as claimed in claim 4, wherein the step of bringing the gaseous mixture into contact with the metal oxide catalyst is performed under a gauge pressure in a range of 0 atm to 2 atm.
